(19) United States
(12) Patent Application Publication
(10) Pub. No.: US 2016/0016755 A1
(43) Pub. Date: Jan. 21, 2016

(54) ELEVATOR GROUP CONTROL WITH DESTINATION CONTROL SYSTEM

(71) Applicants: Ari HANNINEN, Hyvinkaa (FI); Hannu Kuoppala, Helsinki (FI); Janne Aberg, Hyvinkaa (FI); Riku Leppaaho, Hyvinkaa (FI)

(72) Inventors: Ari HANNINEN, Hyvinkaa (FI); Hannu Kuoppala, Helsinki (FI); Janne Aberg, Hyvinkaa (FI); Riku Leppaaho, Hyvinkaa (FI)

(73) Assignee: Kone Corporation, Helsinki (FI)

(21) Appl. No.: 14/870,590

(22) Filed: Sep. 30, 2015

Related U.S. Application Data
(63) Continuation of application No. PCT/EP2013/057211, filed on Apr. 5, 2013.

(51) Int. Cl. B66B 1/24; B66B 1/46

(52) U.S. Cl. CPC B66B 1/2408; B66B 1/468; B66B 2201/103; B66B 2201/4615

(57) ABSTRACT

The invention refers to a group control of an elevator group comprising several elevators, which group control comprises a destination control system with at least one destination call panel for issuing a first destination call by inputting a first destination floor whereupon the destination control system allocates said first destination call to a first elevator of said elevator group. The destination call panel has a link actuator, which, upon activation, initiates the destination control system to receive at least a second destination call with a second destination floor and/or departure floor, which second destination call is also allocated to said first elevator by the destination control system. By this measure passengers with different departure and/or destination floors can travel with the same elevator.

This application is a continuation of PCT International Application No. PCT/EP2013/057211 which has an International filing date of Apr. 5, 2013, the entire contents of which are incorporated herein by reference.

The present invention relates to a an elevator group control with a destination control system comprising at least one destination call panel having buttons to input a destination floor. After issuing a destination call via the panel a first elevator is allocated by the destination control system serving said destination floor. Destination control systems are particularly used in elevator groups with several elevators having quite a lot of destination floors, particularly more than ten floors. Usually after having input a destination call, the elevator is immediately allocated to said destination call and the allocated elevator is communicated to the passenger, usually via a display.

Sometimes in access controlled elevator groups, also identity data of each passenger has to be input to the destination control system, for example by inputting an access number or by presenting an identity card to reading means or wireless by RFIDs, for example.

It is object of the invention to provide a group control with destination control system which is able to consider individual travel needs in a higher amount than it is possible up to now.

The object of the invention is solved with a group control according to claim 1. It is further solved in an allocation method according to claim 12. Preferred embodiments of the invention are subject-matter of the corresponding dependent claims. Some inventive embodiments are also presented in the drawings and in the descriptive section of the present invention. The inventive content may also consist of several separate inventions, especially if the invention is considered in the light of expressions or implicit subtasks or from the point of view of advantages or categories of advantages achieved. In this case, some of the attributes contained in the claims below may be superfluous from the point of view of separate inventive concepts. The features of the various embodiments mentioned above can be applied within the framework of the basic inventive concept in conjunction with other embodiments.

According to the invention, a passenger may issue a destination call via the destination call panel whereupon a first elevator (any of the elevators of the elevator group) is allocated to his call. The destination call panel has a link actuator, e.g. in form of a push button, which upon operation initiates the destination control system for the input of at least a second destination call with a second destination floor and/or departure floor, which second destination call is also allocated to the same first elevator.

The invention offers the advantage that two persons with different destinations and/or even departure floors could use the same elevator. Considered two passengers with different destinations meet at the lobby and discuss a problem, up to now it is a question of random whether these passengers are allocated to the same elevator. With the activation of the link actuator their separate destination calls are allocated to the same elevator. It is of course possible to activate the link activator a second time to add a third destination call to the same elevator.

In current destination control systems, the allocation of an elevator to a destination call is dependent on several allocation parameters as passenger waiting time, riding time, energy consumption, traffic flow properties and so on. It is therefore to be expected that persons with different destination floors are regularly allocated to different elevators. This is detrimental if the persons who met in the lobby of the elevator want to exchange information during the elevator travel. The invention satisfies this need in an easy manner.

Preferably, the link actuator is provided as a push button in the destination call panel which could for example indicated as “AND”. Also different push buttons could be provided depending on the question whether the departure floor for both destination calls is the same, for example an “AND”-button and one “JOIN”-button. The JOIN-button allows the meeting of two persons standing on different starting floors and having the same destination floor. When the passenger presses the JOIN-button, he is invited to enter a second starting floor (aside from the floor where he enters his destination call) which initiates the destination control system to allocate a destination call with the second starting floor and the second destination floor also to the first elevator. Of course, when the second passenger has already given his destination call, his destination call can be retransferred by the destination control system to the first elevator. In case preferably mobile devices are used as a destination call panel, in which case the second passenger can be informed of the reallocation of his destination call via his mobile device.

Sometimes destination control systems have an access control wherein it is obligatory to input identification data into the destination control system before being able to input a destination floor. Sometimes together with the input of the identification data, the destination floor is input automatically. In any case of access control, the actuation of the link actuator initiates the destination control system to enable the input of another identity data and another correlated departure and/or destination floor into the destination call panel. Hereby it is irrespective whether the second departure/destination floor is input manually or automatically via the input of the identity data.

The identity data can be input via an input keypad of the destination call panel or via an identity tag reader which may be a card reader or an RFID reading device. In this case an ID tag could be presented to the ID tag reader of the destination call panel, the link actuator could be pressed and the second ID tag is presented to the ID tag reader.

In a very highly automated system the destination call panel could be reduced to an ID tag reader which automatically gets the departure and destination floors from the ID tag.

Accordingly, the invention in a very simple allows the joining of passengers having different destinations and/or different departure floors for their travel in the elevator group.

In a preferred embodiment of the invention the destination control system comprises a clock circuit for terminating the input of a destination call or of linked destination calls if no further input is received from the destination call panel within a certain time period. Via this measure it can be ensured that the input of destination calls by one passenger is terminated. The time period should be adapted to user habits with the input of data in a destination call panel, e.g. between 2 and 5 seconds. Otherwise also an “END”-button could be provided in the destination call panel to terminate the input of further destination calls to be allocated to one and the same elevator.

The invention also refers to an elevator group having a group control with a destination control system according to the above description.

The invention also refers to a method for allocating landing calls in the destination control system of an elevator group comprising several elevators. In this method, a destination call is issued to the destination control system of the elevator group by inputting a first destination floor into a destination call panel, whereupon a first elevator of the elevator group is allocated to said destination call. According to the invention, a link actuator, e.g. a push button, is provided in said destination call panel whereby the activation or operation of the link actuator allows the issuing of at least one second destination call with a second destination floor and/or a second departure floor which second destination call is also allocated to the first elevator.

The inventive method allows people with different departure and/or destination floors travelling together in the same elevator of the elevator group although it would be highly probable that according to normal allocation goals, where the passenger riding time, waiting time energy consumption or similar targets are optimized, these passengers would be allocated to different elevators.

The invention hereby even allows the joining of passengers with different departure floors and/or different destination floors. Preferably, the link actuator comprises different actuating devices, e.g. push buttons for identical departure floors or different departure floors.

If the departure floors are the same, i.e. the floor on which the destination call is issued, the passenger my press an “AND”-button of the link actuator on the destination call panel, whereupon the destination control system simply awaits the input of a second destination floor or, if the destination control system is access controlled, the input of a second passenger ID, which may comprise a correlated second destination floor. Both destination calls are then allocated to the same elevator of the elevator group.

If the other passengers will enter the elevator at a different departure floor, the passenger preferably adds a different activator of the link actuator as e.g. a “JOIN”-button of the link actuator whereupon the passenger can enter the allocated elevator at a different departure floor. If desirable, the other passenger even may head for a different destination floor. If he doesn't enter a second destination floor, both calls are deemed to comprise the same destination floor.

In case the JOIN-button is pressed and the second destination call has been input into the destination call panel, the destination control system scans the given destination calls for a destination call having the specified departure and destination floor and allocates this/these destination call(s) also to the same elevator. If no destination call with the second departure floor and the second destination floor has been given, the destination control system will allocate the next destination call with said departure/destination data to the same elevator.

Via this method it is therefore possible that passengers with different departure and/or destination floors travel with the same elevator in the elevator group.

When the invention speaks of a destination call panel as an input means, this also comprises the destination call input means on mobile devices which allow for the automatic, semi-automatic or manual input of identity data and/or destination and/or departure floors into the destination control system.

The destination call panels could be reduced to automatic ID reading devices which include all the departure/destination data. In this case the link activator could be provided in connection with the automatic ID reading device, e.g. an ID tag reader.

The invention is particularly designed for a destination control system with immediate call allocation although it is not limited to such systems. The identity data can be input to the destination control system via identity cards, RFID tags or similar devices which are per se known in the art.

The invention could also be used in a multi-group system having several elevator groups which are commonly handled by a multi-group control.

The destination control system is preferably provide in the group control but can also be located elsewhere, e.g. in an elevator control of the elevator group.

The invention will hereinafter be described by the aid of an exemplary embodiment in connection with the drawing.

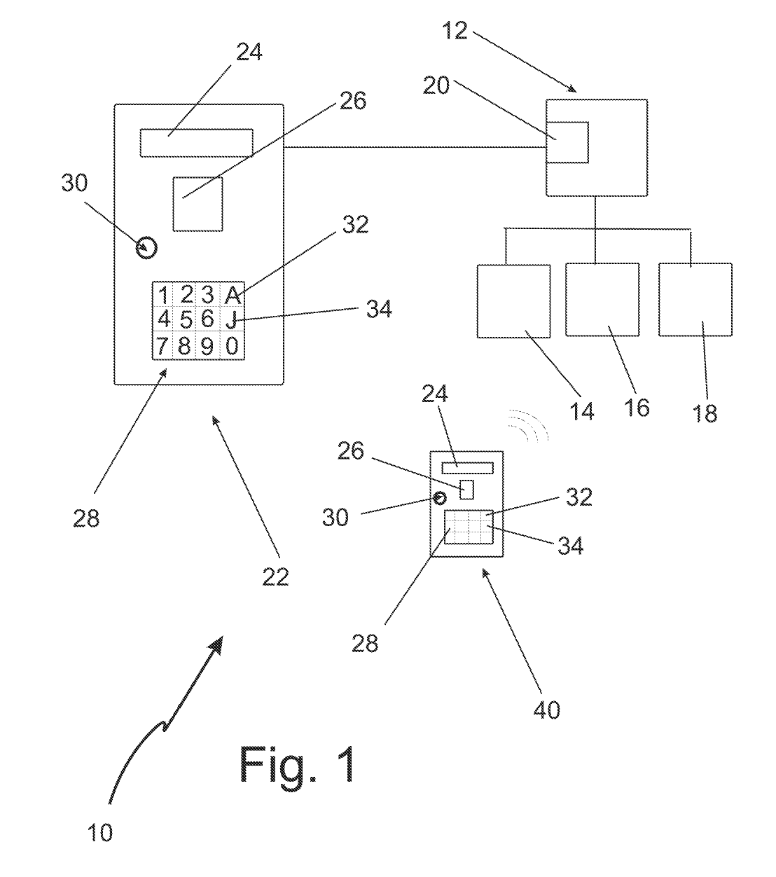

FIG. 1 shows a schematic drawing of an elevator group with destination control system according to the invention.

FIG. 1 shows an elevator group 10 having an elevator group control 12 to which three elevators 14, 16, 18 are connected. The elevator group control 12 comprises a destination control system 20 which is connected to several destination call panels 22 located at different floors in the lobby of the elevators. Each destination call panel comprises an input window 24, a display 26 for the allocated elevator, a decade keyboard 28 for inputting the destination call and an RFID reader 30 to read RFID tags. The destination call panel further comprises an AND-button 32 and a JOIN-button 34.

The destination control system can also communicate wirelessly with a mobile device 40, e.g. a smartphone, which comprises the same functional elements as the destination call panel 22 in a software based application, whereby identical elements or elements with the same function have the same reference number.

The elevator group 10 in FIG. 1 works as follows:

The passenger enters a destination call into the destination call panel 22 by inputting a first destination floor via the decade keyboard 28 or via an ID tag presented to the RFID tag reader 30. After having given his destination call, he presses the AND-button 32 to input a second destination floor via the decade keyboard 28. Alternatively another passenger may present his ID tag to the ID tag reader 30 of the destination call panel. When within a certain time frame the AND- or JOIN button 32, 34 is not pressed a further time, the destination control issues an elevator 14 to both destination calls which elevator is indicated on the display 26 of the destination call panel. The elevator is of course allocated in line with the usual optimization criteria of elevator call allocation, e.g. passenger riding time or waiting time.

If the passenger wants another passenger with a different departure floor to join his travel in the elevator group, he presses the JOIN-button 34 after having issued his own destination call, in which case he is able to input a different departure floor into the destination call panel. In this connection it could also be possible to input for the second destination call a different second destination floor so that it is possible that passengers with different departure floors as well as with different destination floors travel together. In access controlled systems the passenger would have to input the ID of the further passenger manually.

The issuing of corresponding destination calls can also be performed on a mobile device 40. If the destination control system is an access-controlled destination control system, the identity of the passengers could already be communicated to the destination control system via the serial number of the mobile device. In this case, he can enter the identity of the second passenger other by input the second identity data via the decade keyboard 28 or via an ID tag reader 30 in the mobile device.

The invention provides the possibility of social contacts of passengers during a travel in an elevator system although they have different departure and/or destination floors.

Of course, the above-mentioned embodiment is not limited to elevator groups with three elevators. Also the elevator group 10 may be a multi-group system comprising several groups of elevators controlled by a multi-group control system. In this case, the destination control system is preferably provided in the multi-group control.

Furthermore, it is apparent to the skilled person that the destination call panels may be designed differently, i.e. having different input means than a decade keyboard or having the input window 24 and the display 26 provided in one and the same display element. In a very simplified form the destination call panel only may comprise an ID tag reader and the link actuator.

It is furthermore clear that the ID tag reader 30 is optional and that the destination call panel also may have other ID readers as e.g. card readers etc.

The invention can be modified within the scope of the appended patent claims.

1. Group control of an elevator group comprising several elevators, which group control comprises a destination control system with at least one destination call panel for issuing a first destination call by inputting a first destination floor whereupon the destination control system allocates said first destination call to a first elevator of said elevator group, characterized in that the destination call panel has a link actuator, which, upon activation, initiates the destination control system to receive at least a second destination call with a second destination floor and/or departure floor, which second destination call is also allocated to said first elevator.

2. Group control of claim 1, wherein the link actuator comprises at least one push button in the destination call panel.

3. Group control of claim 2, wherein the link actuator comprises a “AND”-button initiating the destination control system to receive a second destination call with a second destination floor.

4. Group control of claim 2, wherein the link actuator comprises a “JOIN”-button initiating the destination control system to receive a second destination call with a different departure floor.

5. Group control of claim 4, wherein the “JOIN”-button initiates the destination control system to receive a second destination floor with the second destination call.

6. Group control according to claim 1, wherein the destination call panel is provided as a software based application on a mobile device which is in bidirectional wireless communication with the destination control system.

7. Group control of claim 6, wherein the destination control system is configured to issue a reallocation-message to the mobile device.

8. Group control according to claim 1, wherein each destination call comprises identification data (ID) of the passenger, and wherein the destination call panel comprises an input means for the ID whereby the actuation of the link actuator initiates the destination control system to enable the input of at least one second ID and a correlated second departure/destination floor.

9. Group control according to claim 8, wherein the input means comprises a wireless ID-tag reader.

10. Group control according to claim 1, wherein the destination control system comprises a clock circuit for terminating the input of a destination call or of linked destination calls if no further input is received from the destination call panel within a certain time period.

11. Elevator group having a group control according to claim 1.

12. Method for allocating landing calls in a destination control system of an elevator group comprising several elevators, in which method a first destination call is issued to the destination control system of the elevator group by inputting a first destination floor into a destination call panel, whereupon said first destination call is allocated to a first elevator of the elevator group, in which method a link actuator is provided in said destination call panel, whereby the activation of the link actuator allows the issuing of at least one second destination call with a second destination floor and/or a second departure floor, which second destination call is also allocated to the first elevator.

13. Method according to claim 12, wherein after the issuing of the second destination call the destination control system checks if any further destination call has been issued from the second destination floor to the first destination floor, and if the result is positive this further destination call is re-allocated to the first elevator.

14. Method according to claim 13, wherein a re-allocation message is signaled to the passenger who has input the further destination call.

15. Method according to claim 12 wherein an ID is input with each destination call, whereby the activation of the link actuator enables the destination control system to input at least a further ID.
